(19) United States
(12) Patent Application Publication
(10) Pub. No.: US 2026/0245095 A1
(43) Pub. Date: Aug. 20, 2026

(54) EXPLAINABLE FRAUD DECISIONING SYSTEM LEVERAGING LARGE LANGUAGE MODELS ("LLMS") AND INTERPRETABLE NEURAL NETWORKS ("INNS")

(71) Applicant: Bank of America Corporation, Charlotte, NC (US)

(72) Inventors: Shorya Sharma, Delhi (IN); Ramanand Shukla, Noida (IN); Shailendra Singh, Maharashtra (IN); Arti Iyer, Maharashtra (IN)

(21) Appl. No.: 19/055,087

(22) Filed: Feb. 17, 2025

(51) Int. Cl. G06Q 20/40; G06F 40/40; G06Q 20/06; G06Q 20/36

(52) U.S. Cl. CPC G06Q 20/4016; G06F 40/40; G06Q 20/06; G06Q 20/36

(57) ABSTRACT

Methods may provide explainable fraud decisioning and fraud alerting to multiple entities within a distributed ledger environment. Methods may monitor transactions on a DeFi network involving multiple entities, use transaction flag metadata while a transaction is hopping across multiple entities and derive an end-to-end contextual heatmap of a transaction leveraging artificial intelligence (“AI”). Methods may identify transaction metadata within the transactions. Methods may generate, by an INN operating with an LLM, a fraud decision and explanation for the transaction. Methods may propagate the fraud decision to the plurality of entities within the distributed ledger environment. Methods may receive an acceptance or rejection of the fraud decision from each entity. The acceptance or rejection may be based on rules specific to the entity. Methods may auto-decision the transaction based on majority consensus received from the plurality of entities.

### FIELD OF TECHNOLOGY

Aspects of the disclosure relate to large language models (“LLMs”) and interpretable neural networks (“INNs”).

### BACKGROUND OF THE DISCLOSURE

Decentralized payment systems, such as cryptocurrency, are becoming increasingly popular. Decentralized payment systems offer faster, cheaper and more transparent transactions when compared to traditional payment systems. However, financial institutions, which have traditionally operated within a centralized framework, face difficulties complying with security regulations and regulatory compliance when transacting within the decentralized environment.

Decentralized payment systems give rise to a new area of challenges. Because traditional fraud detection systems rely on historical data, traditional fraud detection systems are unable to dynamically adapt to new types of fraud. Traditional fraud detection systems are incompatible and inadequate in the context of decentralized payment systems.

Furthermore, traditional deep learning models are considered black box models-i.e., the processing is opaque and not understandable by a human. As such, financial institutions have difficulties in explaining a fraud prevention result. The lack of explainability prevents proactive fraud prevention.

Additionally, in decentralized payment systems, it would be valuable for all participating entities to be informed of and/or understand the reason that a transaction was declined. Such information and understanding may maintain trust and ensure effective collaboration for managing reconciliation, dispute and claim settlement.

An explainable fraud decisioning system leveraging LLMs and INNs may be desirable.

It would be desirable for such a system to proactively prevent fraud within a decentralized payment network.

It would be further desirable for such a system to provide explainable and transparent reasoning for transaction failure.

### SUMMARY OF THE DISCLOSURE

Systems, apparatus and methods for an explainable fraud decisioning system leveraging LLMs and INNs are provided.

Methods may include initiating a decentralized payment transaction request at a decentralized finance (“DeFi”) network. The decentralized payment transaction request may include one or more transaction details. The decentralized payment transaction request may be initiated at a user digital wallet or banking application.

The DeFi network may include the financial entity associated with an initiator of the transaction request or user. The DeFi network may include a financial entity associated with a recipient of the payment transaction request. The recipient of the payment transaction request and the financial entity associated with the recipient of the payment transaction request may be identified in the transaction details or data.

Methods may include verifying the payment transaction request including the one or more transaction details. The verification may be executed at a financial entity. The financial entity may be associated with the user.

Upon successful verification, methods may include authorizing the payment transaction request. The verification may be executed at the financial entity.

Upon successful verification, methods may include forwarding the payment transaction request and the one or more transaction details from the financial entity to a central coordinating entity.

Methods may include receiving the payment transaction request and the one or more transaction details at the central coordinating entity. The financial entity may be included in the entities linked to the central coordinating entity. The user may be included in the entities linked to the central coordinating entity.

Methods may include initiating an inter-entity settlement process at the central coordinating entity. The inter-entity settlement process may involve a portion of the entities within the DeFi network. The inter-entity settlement process may include recording the payment transaction request on the decentralized payment platform using blockchain technology. The inter-entity settlement process may include executing the payment transaction request using smart contract technology.

Methods may include ingesting transaction data of the payment transaction request at a multi-modal fusion layer within the central coordinating entity. Ingesting the transaction data may be executed upon completion of the inter-entity settlement process.

At times, the inter-entity settlement process may be processed and revocable until completion of the processing by the central coordinating entity. Other times, the inter-entity settlement process may be irrevocable, and the processing provided by the central coordinating entity may be informative to the remaining entities within the network for future transactions.

Methods may include normalizing the transaction data at a multi-modal fusion layer. Normalizing the transaction data may include reformatting the transaction data into a format ingestible by an INN engine.

Methods may include ingesting the reformatted transaction data at the INN engine. Methods may include processing the reformatted transaction data through the INN engine. Methods may include outputting, at the INN engine, a tag for the reformatted transaction data. The tag may be a suspicious tag (label the transaction as suspicious) or a trusted tag (label the transaction as trusted). The tag may be formatted as a decision tree and decision boundaries. The decision tree and the decision boundaries may not be easily readable by a human or entity.

Methods may include inputting the tag formatted as a decision tree and decision boundaries to an LLM. Methods may include generating, at the LLM, a natural language description of the tag. Methods may include outputting, from the LLM, the natural language description of the tag. Methods may include triggering a webhook payload notification to all entities within the decentralized payment network (linked to the central coordinating entity).

The webhook payload notification may include the natural language description of the tag. The webhook payload notification may include one or more executables relating to fraud detection. The webhook payload notification may include one or more executables enabling an initiator of the transaction to perform identity verification and/or appeal the suspicious tag. The webhook payload notification may include a block to be recorded on a blockchain on which the entities linked to the central coordinating entity are nodes. The block may include the transaction details, the tag and/or the natural language description of the tag.

Methods may include receiving responses from the entities within the network. The responses may be received in response to transmission of the webhook payload notification. The responses may include acceptance or rejection of the tag associated with the payment transaction request and/or a reason for the acceptance or rejection of the tag. The reason for the acceptance of the suspicious tag may include specific detected fraud patterns. The reason for the acceptance of the suspicious tag may include anomalies detected in transaction data.

Methods may include generating an auto-decisioning transaction reconciliation based on the received responses. The auto-decisioning transaction reconciliation may include voiding the payment transaction request based on the received responses.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows an illustrative flow chart in accordance with principles of the disclosure;

FIG. 4 shows another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIGS. 7A and 7B show yet another illustrative diagram in accordance with principles of the disclosure;

FIG. 8 shows still another illustrative diagram in accordance with principles of the disclosure; and

FIG. 9 shows yet still another illustrative diagram in accordance with principles of the disclosure.

### DETAILED DESCRIPTION OF THE DISCLOSURE

Systems, apparatus and methods for an explainable fraud decisioning system are provided. The explainable fraud decisioning system may leverage and/or include an LLM and an INN.

The system may include a decentralized finance (“DeFi”) network. The DeFi network may include a blockchain. The DeFi network may include a plurality of entities. Each of the entities included in the plurality of entities may be operable to initiate a transaction. Each of the entities included in the plurality of entities may be operable to participate in the blockchain. Each of the entities included in the plurality of entities may be operable to communicate with a centralized coordinating entity (“CCE”). Each of the entities included in the plurality of entities may be operable to flag the transaction based on one or more entity-specific rules. It should be noted that each entity may create a set of rules based on information specific to the entity. Information specific to the entity may include historical transactions in which the entity was a party.

The system may include a CCE. It should be noted that the CCE may be an entity included within the DeFi network. The CCE may include a multi-modal fusion layer, an INN engine and/or an LLM engine.

The multi-modal fusion layer may normalize the transaction in a format ingestible by an INN engine. At times, each entity within the DeFi network may execute transactions with a unique format using a unique rule set. The transactions may be received at the multi-modal fusion layer as feature vectors, including a unique set of features which have been converted to one or more vectors. The multi-modal fusion layer may combine the feature vectors for a transaction into a unified representation. The unified representation may be ingestible by the INN engine.

In response to receipt of the unified representation and/or the normalized transaction at the INN engine, the INN engine may output a flag for the transaction. The flag may label the transaction as suspicious or trusted (also referred to herein as non-suspicious). The flag may also include one or more reasons why the flag was selected. The flag may be formatted as a decision tree and decision boundaries. A decision tree may be a supervised machine learning algorithm that recursively splits the data based on different attributes (features) and their thresholds. The decision tree creates decision boundaries that divide the feature space into regions associated with specific classes. An example of classes may include suspicious transactions or trusted transactions. The decision tree and decision boundaries generated by the INN engine may not be human readable. The decision tree and decision boundaries generated by the INN engine may not be easily ingestible by an entity included in the DeFi network. As such, the INN may input the flag to the LLM engine.

The LLM engine may ingest the output of the INN engine. The LLM may process the output of the INN engine into a set of natural language comments for the transaction. The set of natural language comments may include whether the transaction was flagged as suspicious or trusted and/or one or more reasons why the transaction was flagged as such. The LLM engine may create a webhook payload for the transaction. The webhook payload may include the transaction, the flag and the natural language comments. At times, the webhook payload may include the natural language comments without the decision tree and decision boundaries. The LLM engine may transmit the webhook payload to each entity within the DeFi network.

A first transaction may be initiated at a first entity within the DeFi network or plurality of entities. The first transaction may be processed at the first entity. A notification relating to the first transaction may be transmitted to the CCE. The multi-modal fusion layer, at the CCE, may normalize the transaction. The INN, at the CCE, may label the first transaction as suspicious or trusted. The LLM may receive, as input, the first transaction and/or the label. The LLM may output a set of natural language comments for the first transaction and the label. The LLM may create a first webhook payload for the first transaction. The webhook payload may include the first transaction, the flag and/or the natural language comments. The LLM may transmit the first webhook payload to each entity within the DeFi network.

Each entity within the DeFi network may flag the first transaction as suspicious or trusted based on the entity-specific rules. The DeFi network may identify the first transaction as suspicious or trusted based on a majority consensus of the flags provided by the entities within the DeFi network. The DeFi network may execute the first transaction when the first transaction is identified as trusted.

When the DeFi network identifies the first transaction as trusted, a block comprising the transaction, the flag, the natural language comments and/or the consensus may be generated at one or more entities within the DeFi network. In some embodiments, when the DeFi network identifies the first transaction as suspicious, a block may not be created for the transaction. In certain embodiments, when the DeFi network identifies the first transaction as suspicious, a block may be created for the transaction, however, the block may identify the first transaction as suspicious.

One or more entities within the DeFi network may instruct the addition of the block to the blockchain. The entities within the DeFi network may add the block to the blockchain.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

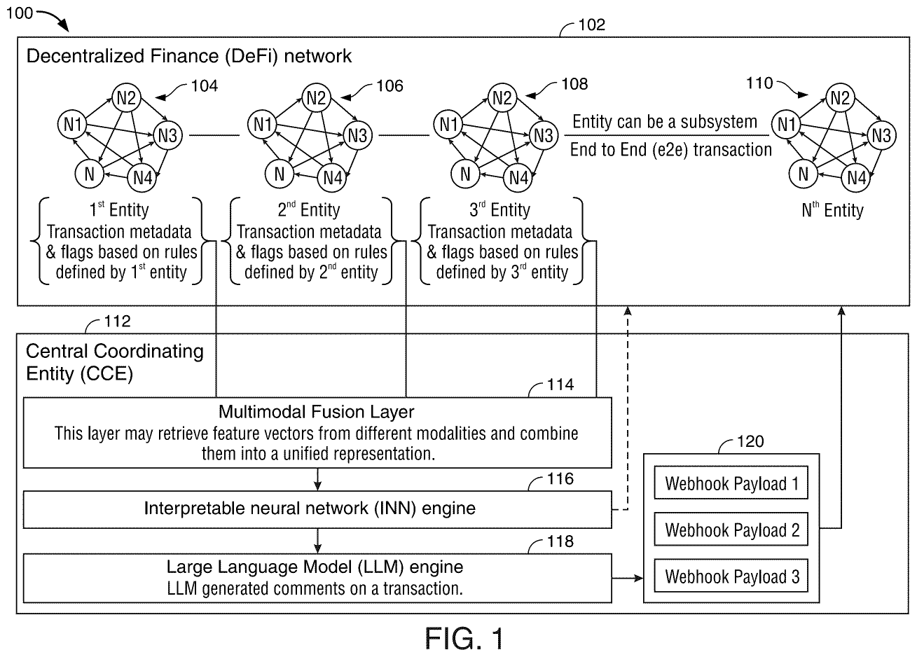

FIG. 1 shows an illustrative diagram. A decentralized finance (“DeFi”) network is shown at 102. A central coordinating entity (“CCE”) is shown at 104. Multiple entities may be included within DeFi network 102. DeFi network 102 may include a first entity, shown at 106, a second entity, shown at 108 and a third entity, shown at 110. DeFi network 102 may include additional entities, as indicated by Nth entity, shown at 112. First entity, shown at 106, may include a plurality of transaction metadata. First entity, shown at 106, may flag one or more transactions based on rules defined by the first entity. Second entity, shown at 108, may include a plurality of transaction metadata. Second entity, shown at 108, may flag one or more transactions based on rules defined by the second entity. Third entity, shown at 110, may include a plurality of transaction metadata. Third entity, shown at 110, may flag one or more transactions based on rules defined by the third entity.

Examples of transaction metadata may include business rules, AI/ML parameters, transaction parameters, a transaction source and a transaction destination, transaction properties, customer profile data (a customer that initiated the transaction), negative list flags and white list flags.

The transaction metadata, flagged transactions and/or rules defined by each entity, may be transmitted to multimodal fusion layer 114. Multimodal fusion layer 114 may take feature vectors from different modalities (each of the entities may structure the transaction metadata, flagged transactions and/or rules in a different modality) and combine the feature vectors into a unified representation. Multimodal fusion layer 114 may transfer the extracted feature vectors in addition to the transaction metadata, the flagged transactions and the rules to interpretable neural network (“INN”) 116. An INN is a type of neural network architecture designed to provide transparent and interpretable explanations for the predictions that the INN generates. Unlike traditional neural networks that may be referred to colloquially as “black box models,” in which the internal processes are difficult to understand, INNs are specifically designed to be interpretable. As such, INNs are suitable for applications where understanding the reasoning behind the prediction is important.

INN 116 may analyze the reasoning for decisions made by each of entities 106, 108 and 110. The reasoning generated by INN 116 in addition to the extracted feature vectors, the transaction metadata, the flagged transactions and the rules may be transferred to large language model (“LLM”) 118. An LLM is a computational model notable for the ability to achieve general-purpose language generation and other natural language processing tasks such as classification. LLM 118, using the data and information provided by INN 116, may generate comments on an in-progress transaction.

LLM 118 may trigger webhook payloads 120. Each of webhook payloads 120 may be directed to be transmitted to one or more entities. The webhook payloads may describe reasoning for an anomaly within an in-progress transaction. Based on the anomaly, entities may auto-execute acceptance or rejection of a transaction.

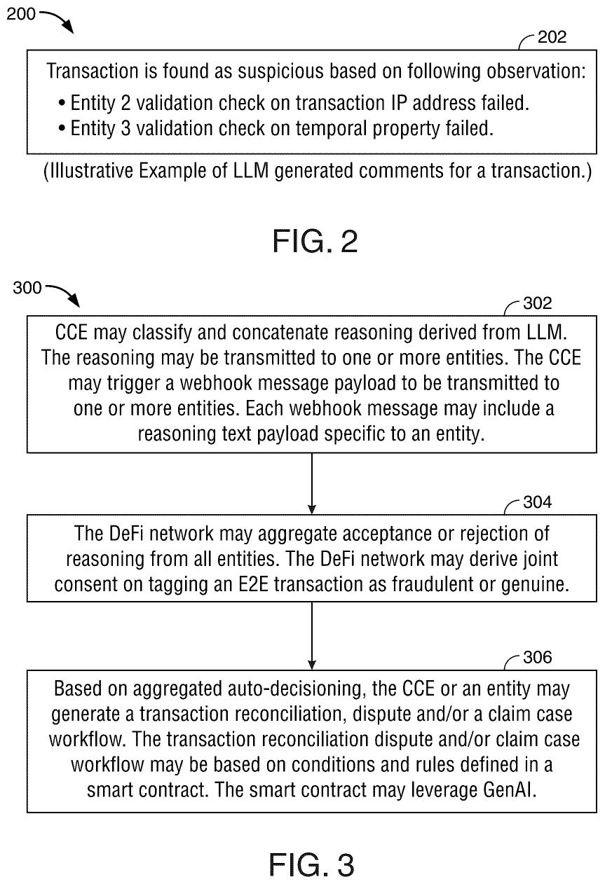

FIG. 2 shows an illustrative diagram. The illustrative diagram shows exemplary comments 202. Exemplary comments 202 are comments generated by an LLM. Comments 202 may correspond to a transaction. Comments 202 may indicate that a transaction is found suspicious. Comments 202 may indicate reasoning that the LLM determined that the transaction is found suspicious. The reasoning may include that entity 2 validation check on transaction IP (“internet protocol”) address failed. The reasoning may include that entity 3 validation check on temporal property failed.

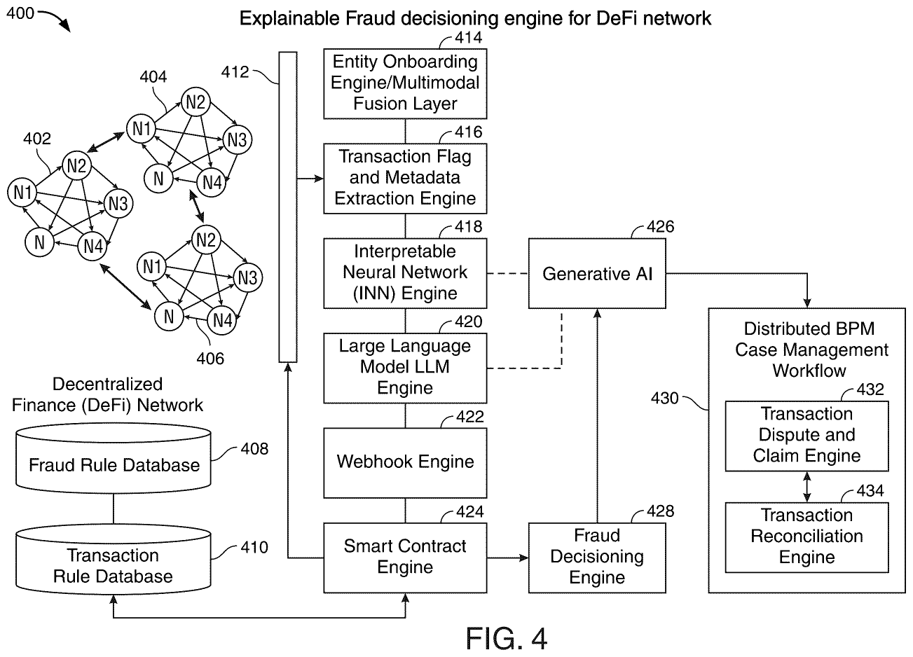

FIG. 3 shows an illustrative flow chart. The flow chart shows steps of a method. Step 302 shows a CCE may classify and concatenate reasoning derived from an LLM. The reasoning may be transmitted to one or more entities. The central coordinating entity may trigger a webhook message payload to be transmitted to the one or more entities. Each webhook message may include a reasoning text payload specific to an entity. As such, the webhook message payload may include recipient-specific data.

Step 304 shows a DeFi network may aggregate acceptance or rejection of reasoning from all entities. The DeFi network may derive joint consent on tagging an E2E (end-to-end) transaction as fraudulent or genuine. At times, one or more of the entities may be unavailable. In such embodiments, another entity may be authorized to accept or reject the reasoning on behalf of the unavailable entity. In other embodiments, in the event that a majority consensus in received, the unavailable entity may not be necessary to complete the tagging the transaction as fraudulent or genuine.

Step 306 shows, based on aggregated auto-decisioning, the central coordinating entity and/or one or more nodes on the DeFi network may generate a transaction reconciliation, a dispute and/or a claim case workflow. The transaction reconciliation, dispute and/or claim case workflow may be based on conditions and rules defined in a smart contract. The smart contract may leverage generative artificial intelligence (“GenAI”).

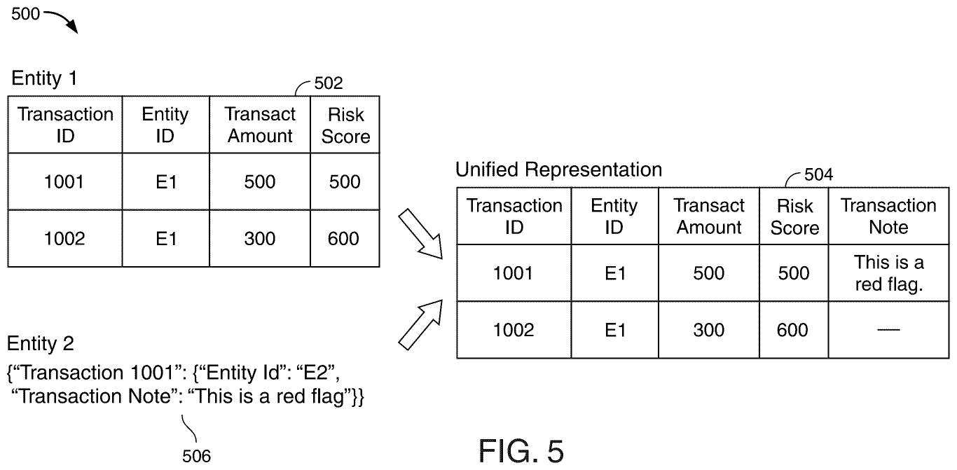

FIG. 4 shows an illustrative diagram. The illustrative diagram shows an explainable fraud decisioning engine 400 for a DeFi network. The DeFi network may include entity 402, entity 404 and entity 406. The DeFi network may include a graphical processing unit (“GPU”) computing infrastructure, indicated by bar 412. GPU computing infrastructure 412 may include a hardware processor, hardware memory and any other suitable hardware components. GPU computing infrastructure 412 may include a GenAI system and an INN. GPU computing infrastructure 412 may be linked to one or more distributed ledgers. GPU computing infrastructure 412 may be able to understand and identify fraud autonomously.

Entity Onboarding engine/multi-modal fusion layer 414 may provide a gateway for entities to onboard to a system. Once a device or network becomes an entity or node on the DeFi network, the entity may be onboarded to the fraud identification service at entity onboarding engine/multi-modal fusion layer 414.

Transaction flag and metadata extraction engine 416 may aggregate flags generated by entities. INN engine 418 may determine why a transaction, or a portion of a transaction, is labeled suspicious. INN may also identify a section of the transaction, or specific transaction metadata element, that caused the transaction to be labeled suspicious. INN engine 418 may leverage GenAI, as shown at 426.

LLM 420 may convert the output of INN engine 418 into natural language output. The natural language output may be understandable by substantially all of the entities included in the DeFi network. LLM 420 may also leverage GenAI, as shown at 426.

The natural language output may be input into Webhook engine 422. Webhook engine 422 may create a webhook for each of the entities within the DeFi network. The webhook may include the natural language output.

Smart contract engine 424 may transmit the webhooks to the entities within the DeFi network. Smart contract engine 424 may execute a smart contract associated with the transaction on a blockchain of the DeFi network. The smart contract may include automatically accepting a transaction-e.g., adding a transaction as a block to a DeFi network blockchain-or automatically rejecting a transaction based on a set of rules. The rules may be different for each entity. The rules may be included within transaction rule database 410 and/or fraud rule database 408.

Fraud decisioning engine 428, in communication with smart contract engine 424, leveraging GenAI 426, may label a transaction as suspicious or trusted. Fraud decisioning engine 428 may be based on a majority of consensus of the entities included in the DeFi network. The majority consensus may be based on the completion of the smart contracts by smart contract engine 424.

Distributed business process management (BPM) case management workflow 430 may enable an entity, customer or user to dispute a transaction. Distributed BPM case management workflow 430 may include a transaction dispute and claim engine 432 and a transaction reconciliation engine 434.

Once a transaction is labeled suspicious, it may be routed to multiple entities. A failed transaction may be because of two entities. As such, information regarding the failure may be transmitted to the two entities.

Transaction dispute and claim engine 432 may create a case. Transaction dispute and claim engine 432 may manage the case by communicating with the various parties of the transaction, including the initiator, entity and recipient.

Transaction reconciliation engine 434 may reconcile a suspicious transaction. Reconciliation of a suspicious transaction may include generating a transaction settlement.

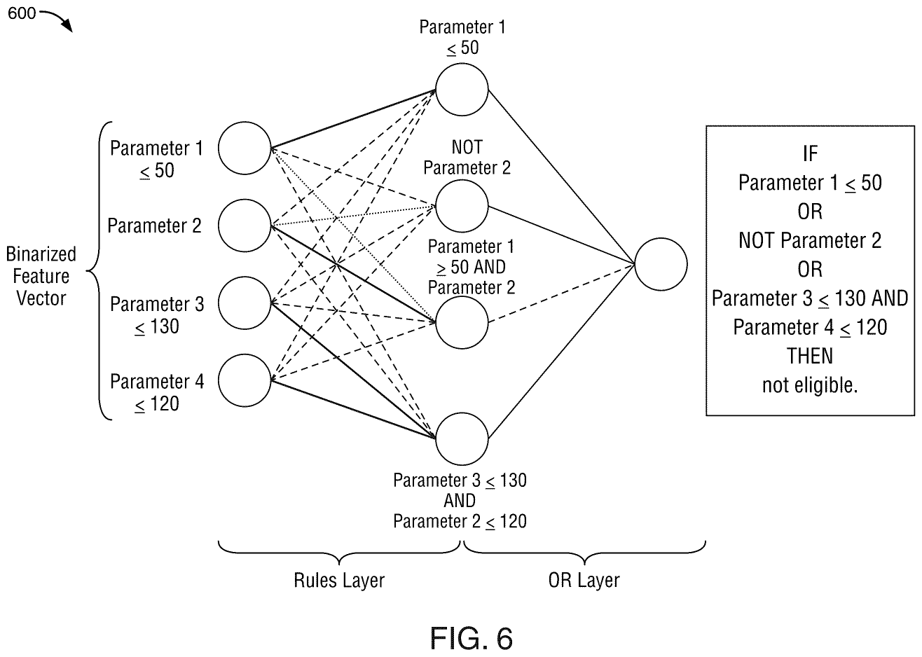

FIG. 5 shows an illustrative diagram. Diagram 500 shows the transformation of a multi-modal fusion layer. A multi-modal fusion layer may be a data processing engine that combines information from multiple data sources-i.e., modalities-into a unified representation. In DeFi networks, entities may provide data that is relevant to the entity's framework. Data provided by each entity include different metadata sets. For example, a first entity may provide a score, while a second entity may provide risk classification of a transaction, such as low risk, medium risk or high risk. The multi-modal layer may ensure that the different metadata sets and types are converted into a format ingestible by the INN. A multi-modal fusion layer may also be referred to as an extract, transform and load system.

Diagram 500 shows transaction data and metadata, shown at 502, output by entity 1, and transaction data and metadata, shown at 506, output by entity 2. It should be noted that transaction 1001 may be included in the transaction data of both entity 1 and entity 2, however, the format and one or more data fields may be different from entity 1 to entity 2. Unified representation 504 may be a conversion and collaboration of the data and metadata 502 and data and metadata 506. Unified representation 504 may include transaction flags and associated metadata as well as action patterns.

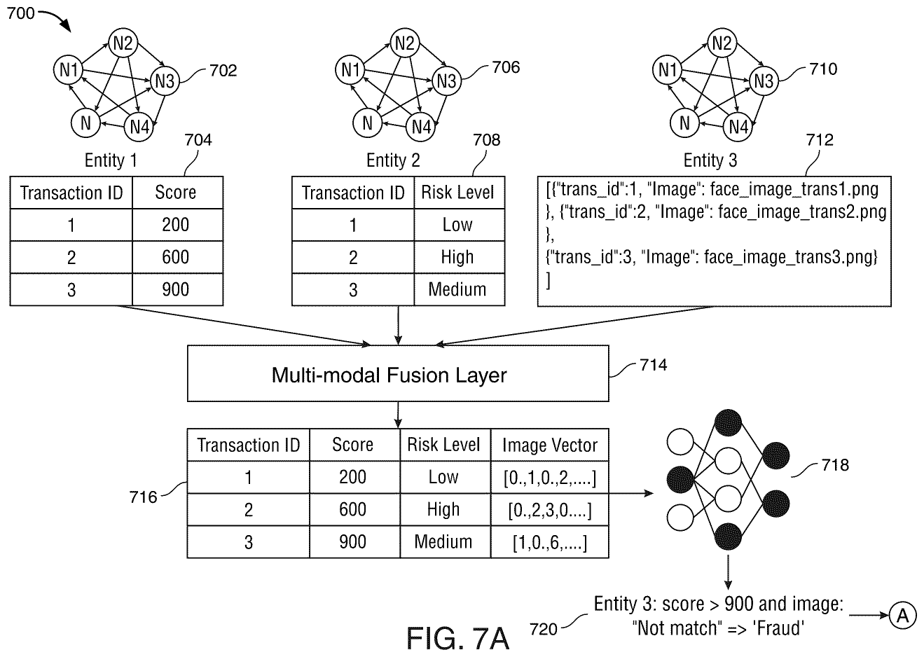

FIG. 6 shows an illustrative diagram. Diagram 600 shows an INN. INNs may be a type of neural network designed to provide transparency and understandability in their decision-making process. The INN may receive the unified representation provided by the multi-modal fusion layer. The INN may analyze the unified representation for suspicious activities and/or transactions. The INN may highlight which features contribute most to the decision-making process. The INN may output a decision-i.e., suspicious or trusted-and a decision tree and decision boundaries relating to the reasoning for the decision. The output of the INN may be input to the LLM.

An LLM may be a type of artificial intelligence model designed to understand, process and generate natural language. LLMs may be trained on vast amounts of data and technology. Certain LLMs may be specifically trained on financial data. LLMs may be capable of performing natural language processing tasks such as text summarization, answering questions, text interpretation and providing natural language explanations. LLMs may be able to transform raw technical insights or explanations from the underlying data models, such as output of the INN, into natural language narratives. The LLM may provide a broader context to a fraud detection process. Specifically, the INN may focus on specific data features, while the LLM may add business logic, market trends or contextual references to explain the reasoning a transaction is labeled suspicious.

The narratives may be understood by various stakeholders within entities in the DeFi network.

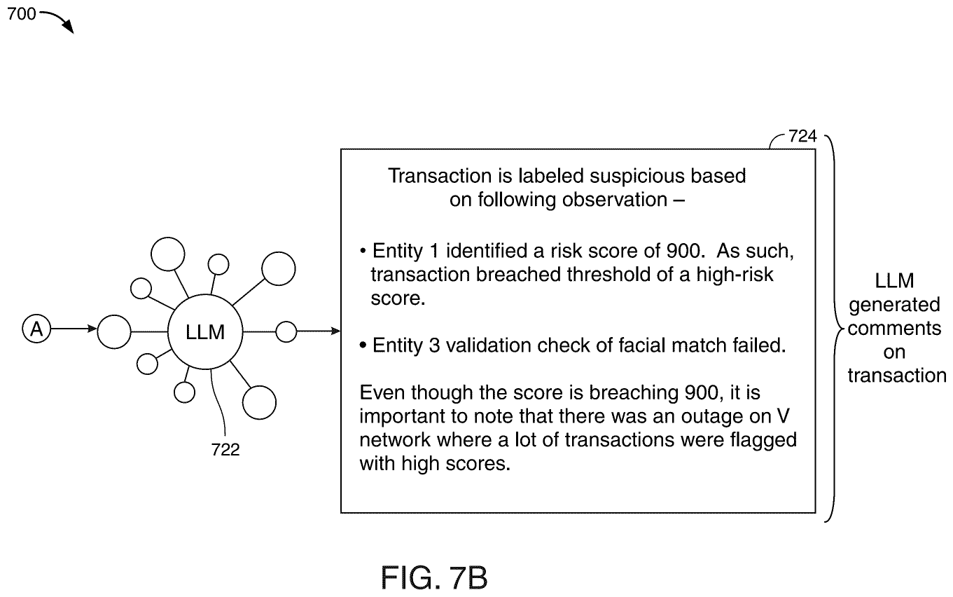

FIGS. 7A and 7B show an illustrative diagram. Illustrative diagram 700 shows a process flow of electronic communications between entities, included in a DeFi network, a multi-modal fusion layer, an INN and an LLM.

Entity 702 may generate a transaction data and metadata output, shown at 704. Entity 706 may generate a transaction data and metadata output, shown at 708. Entity 710 may generate a transaction data and metadata output, shown at 712. Multi-modal fusion layer 714 may combine output 708, output 710 and output 712 into a combined output 716. Combined output 716 may be ingested by INN 718. INN 718 may generate a fraud decision for one or more transactions included in combined output 716. INN 718 may input the fraud decision to LLM 722. LLM 722 may generate a set of natural language comments 724 for each transaction.

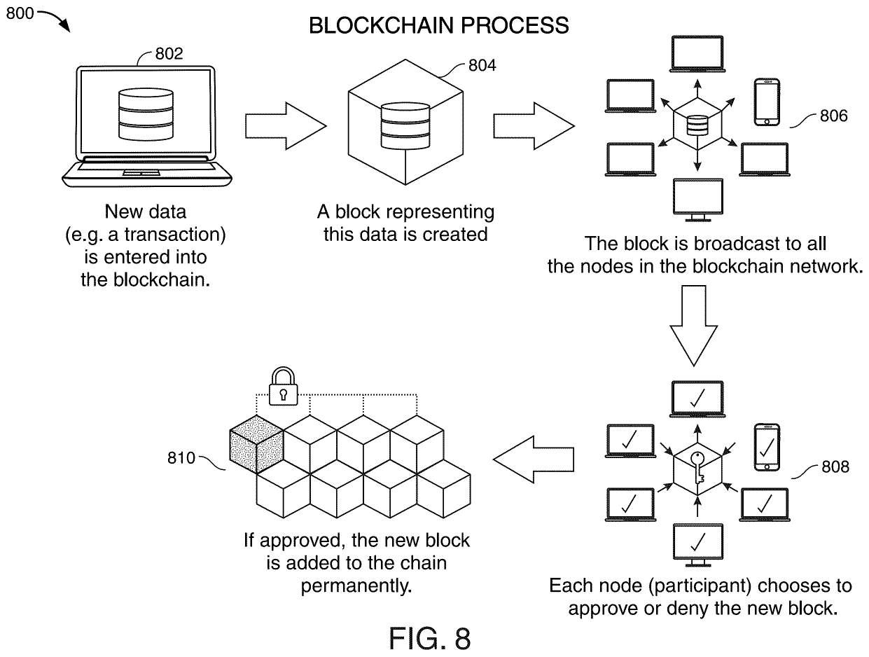

FIG. 8 shows an illustrative diagram. The illustrative diagram shows blockchain process 800. Step 802 of blockchain process 800 includes a new data, such as a transaction, entered into the blockchain. Step 804 shows a block representing this data is created. Step 806 shows the block is broadcast to all the nodes in the blockchain network. Step 808 shows each node (participant) chooses to approve or deny the new block. Step 810 shows the new block is permanently added to the chain if approved.

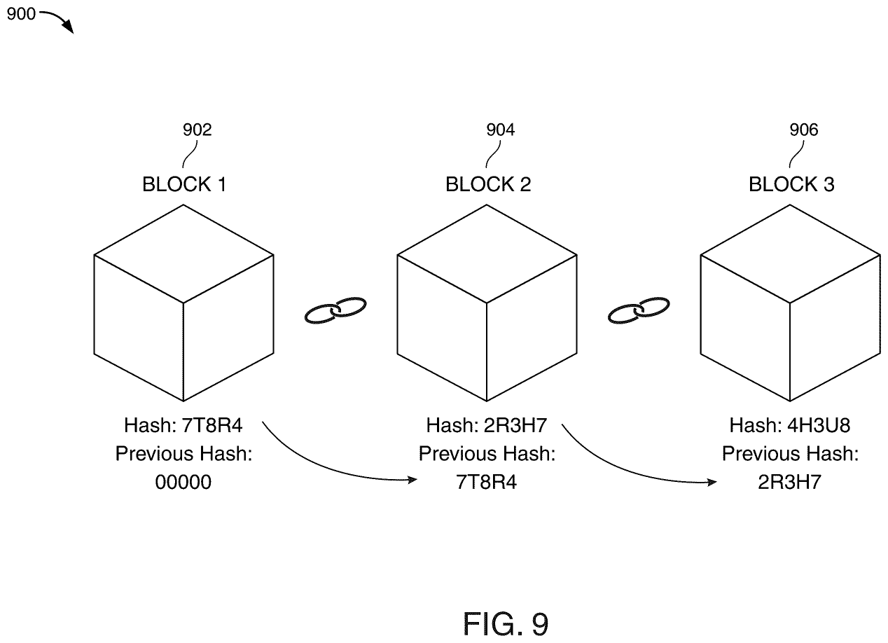

FIG. 9 shows an illustrative diagram. Illustrative diagram 900 shows blocks within a blockchain. Block 1, shown at 902, may include a hash as well as a previous block's hash. Block 2, shown at 904, may include a hash as well as a block 1's hash. Block 3, shown at 906, may include a hash as well as block 2's hash.

Thus, methods and apparatus for an explainable fraud decisioning system leveraging LLMs and INNs are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for providing an explainable fraud decisioning system leveraging large language models (“LLMs”) and interpretable neural networks (“INNs”), the method comprising:
initiating, at a user digital wallet or banking application, a decentralized payment transaction request, said decentralized payment transaction request comprising one or more transaction details;
verifying, at a financial entity associated with the user, the decentralized payment transaction request comprising the one or more transaction details;
upon successful verification:
authorizing, at the financial entity, the decentralized payment transaction request; and
forwarding the payment transaction request and the one or more transaction details from the financial entity to a central coordinating entity;
receiving, at the central coordinating entity, the payment transaction request and the one or more transaction details;
initiating, at the central coordinating entity, an inter-entity settlement process, said inter-entity settlement process comprising:
recording the payment transaction request on a decentralized payment platform using blockchain technology; and
executing the payment transaction request using smart contract technology;
ingesting, at a multi-modal fusion layer, transaction data of the payment transaction request; and
normalizing, at a multi-modal fusion layer, the transaction data to a format ingestible by an INN engine;
ingesting the reformatted transaction data at the INN engine;
processing the reformatted transaction data through the INN engine;
outputting, at the INN engine, a tag for the reformatted transaction data, said tag being a suspicious tag or a trusted tag, said tag formatted as a decision tree and decision boundaries;
inputting the tag formatted as a decision tree and decision boundaries to an LLM;
generating, at the LLM, a natural language description of the tag;
outputting, from the LLM, the natural language description of the tag;
triggering a webhook payload notification to all entities linked to the central coordinating entity, said webhook payload notification comprising:
the natural language description of the tag;
one or more executables relating to fraud detection;
one or more executables enabling the user to perform identity verification and/or appeal the suspicious tag; and
a block to be recorded on a blockchain on which the entities linked to the central coordinating entity are nodes, the block comprising:
the transaction details;
the tag; and
the natural language description of the tag;
receiving, in response to transmission of the webhook payload notification, from the entities linked to the central coordinating entity, responses comprising:
acceptance or rejection of the tag associated with the payment transaction request; and
a reason for the acceptance or rejection of the tag; and
generating an auto-decisioning transaction reconciliation based on the received responses.

2. The method of claim 1 wherein the entities linked to the central coordinating entity comprise:
the financial entity associated with the user; and
a financial entity associated with a recipient of the payment transaction request, said recipient of the payment transaction request and the financial entity associated with the recipient of the payment transaction request identified in the transaction data.

3. The method of claim 1 wherein the financial entity is included in the entities linked to the central coordinating entity.

4. The method of claim 1 wherein the user is included in the entities linked to the central coordinating entity.

5. The method of claim 1 wherein the reason for the acceptance of the suspicious tag is specific detected fraud patterns.

6. The method of claim 1 wherein the reason for the acceptance of the suspicious tag is anomalies detected in transaction data.

7. A method for providing an explainable fraud decisioning system leveraging large language models (“LLMs”) and interpretable neural networks (“INNs”), the method comprising:
initiating, at a banking application, a decentralized payment transaction request, said decentralized payment transaction request comprising one or more transaction details;
verifying, at a financial entity included in a decentralized finance network, the payment transaction request comprising the one or more transaction details;
upon successful verification:
authorizing, at the financial entity, the payment transaction request at the financial entity; and
forwarding the payment transaction request and the one or more transaction details from the financial entity to a central coordinating entity of the decentralized finance network;
upon receipt of the payment transaction request and the one or more transaction details, initiating, at the central coordinating entity, an inter-decentralized-finance-network-entity settlement process, said inter-decentralized finance network-entity settlement processing comprising:
recording, using blockchain technology, the payment transaction request on a decentralized payment platform of the decentralized finance network; and
executing the payment transaction request using smart contract technology;
ingesting, at a multi-modal fusion layer, transaction data of the payment transaction request; and
normalizing, at a multi-modal fusion layer, the transaction data to a format ingestible by an INN engine;
ingesting the reformatted transaction data at the INN engine;
processing the reformatted transaction data through the INN engine;
outputting, at the INN engine, a suspicious tag for the reformatted transaction data, said suspicious tag formatted as a decision tree and decision boundaries;
inputting the suspicious tag formatted as a decision tree and decision boundaries to an LLM;
generating, at the LLM, a natural language description of the suspicious tag;
outputting, from the LLM, the natural language description of the suspicious tag;
triggering a webhook payload notification to all entities within the decentralized finance network, said webhook payload notification comprising:
the natural language description of the tag;
one or more executables relating to fraud detection;
one or more executables enabling a user to perform identity verification and/or appeal the suspicious tag; and
a block to be recorded on a blockchain on which the entities within the decentralized finance network are nodes, the block comprising:
the transaction details;
the tag; and
the natural language description of the tag;
receiving, in response to transmission of the webhook payload notification, from the entities linked to the central coordinating entity, responses comprising:
acceptance or rejection of the tag associated with the payment transaction request; and
a reason for the acceptance or rejection of the tag; and
generating an auto-decisioning transaction reconciliation comprising voiding the payment transaction request based on the received responses.

8. The method of claim 7 wherein the decentralized finance network comprises a financial entity associated with a recipient of the payment transaction request, said recipient of the payment transaction request and the financial entity associated with the recipient of the payment transaction request identified in the transaction data.

9. The method of claim 7 wherein an initiator of the payment transaction request is included in the entities linked to the central coordinating entity.

10. The method of claim 7 wherein the reason for the acceptance of the suspicious tag is specific detected fraud patterns.

11. The method of claim 7 wherein the reason for the acceptance of the suspicious tag is anomalies detected in transaction data.

12. An explainable fraud decisioning system leveraging a large language model (“LLM”) and an interpretable neural network (“INN”), the system comprising:
a decentralized finance (“DeFi”) network, the DeFi network comprising:
a blockchain; and
a plurality of entities, each of the plurality of entities is operable to:
initiate a transaction;
participate in the blockchain;
communicate with a centralized coordinating entity (“CCE”); and
flag the transaction based on one or more entity-specific rules;
the CCE comprising:
a multi-modal fusion layer operable to normalize the transaction in a format ingestible by an INN engine;
the INN engine operable to output a flag for the transaction, said flag labeling the transaction as suspicious or non-suspicious; and
an LLM engine operable to:
ingest the output of the INN engine; and
output a set of natural language comments for the transaction;
create a webhook payload for the transaction, said webhook payload comprising the transaction, the flag and the natural language comments; and
transmit the webhook payload to each entity within the DeFi network;
wherein:
a first transaction is initiated at a first entity within the plurality of entities;
the first transaction is processed as the first entity;
a notification relating to the first transaction is transmitted to the CCE;
the multi-modal fusion layer, at the CCE, normalizes the transaction;
the INN, at the CCE, labels the first transaction as suspicious or non-suspicious;
the LLM receives, as input, the first transaction and the label;
the LLM outputs a set of natural language comments for the first transaction and the label;
the LLM creates a first webhook payload for the first transaction, said webhook payload comprising the first transaction, the flag and the natural language comments;
the LLM transmits the first webhook payload to each entity within the DeFi network;
each entity within the DeFi network flags the first transaction as suspicious or non-suspicious based on the entity-specific rules; and
the DeFi network identifies the first transaction as suspicious or non-suspicious based on a majority consensus of the flags provided by the entities within the DeFi network.

13. The system of claim 12 wherein the DeFi network executes the first transaction identified as non-suspicious.

14. The system of claim 13 wherein one or more entities within the DeFi network:
creates a block for the first transaction, the block identifies the first transaction as non-suspicious; and
instructs the entities within the DeFi network to add the block to the blockchain.

15. The system of claim 12 wherein the DeFi network executes the first transaction identified as suspicious.

16. The system of claim 15 wherein each entity within the DeFi network creates a block for the first transaction, the block identifies the first transaction as suspicious.
